(19) United States
(12) Patent Application Publication
(10) Pub. No.: US 2016/0048845 A1
(43) Pub. Date: Feb. 18, 2016

(54) METHOD FOR ELIMINATING THE USE OF PAPER IN ELECTRONIC TRANSACTIONS BY LEGALLY VALID MANUSCRIPT BIOMETRICS, SO-CALLED FORMALISED PAPERLESS SOLUTION

(71) Applicant: NORTE CRED FORMALIZAR SOLUÇÕES TECNOLÓGICAS LTDA, São Paulo, SP (BR)

(72) Inventor: João BATISTA DE ALMEIDA FONSECA, São Paulo (BR)

(21) Appl. No.: 14/653,845

(22) PCT Filed: Aug. 21, 2013
(86) PCT No.: PCT/BR2013/000433

§ 371 Date: Oct. 19, 2015

(30) Foreign Application Priority Data
Dec. 19, 2012 (BR) BR1020120324512

(51) Int. Cl. G06Q 30/00; G06Q 50/18; G06F 21/32

(52) U.S. Cl. CPC G06Q 30/018; G06F 21/32; G06Q 50/18; G06Q 2220/10

(57) ABSTRACT

The purpose of this instrument is to describe the invention patent classified in the field of operational control systems, which is characterized for being consisted of a negotiation simulator, data entry and capture of image that transmits the record (electronic signature card) for an electronic signature on the agreement (biometrics), through e-CNPJ and back-office (formalization), sending and receiving data for entry and recording, so as to verify the existence of frauds, and, if the process is in compliance, the record is send to the Treasury, and an email is sent to the client via encrypted electronic file (digital envelope) and forwarded right after to e-vault.

### FIELD OF THE INVENTION

This descriptive report sets forth the patent of invention of a new legally valid electronic operation process, especially for the purpose of substituting paper-based operations, which has an innovative conception and important technological and operational improvements, according to modern concepts and the rules and specifications required, and which embodies particularly new and innovative characteristics, thereby resulting in a series of real and extraordinary technical, practice and economic advantages.

### BACKGROUND

Retail companies currently use paper-based processes to formalize their agreements, which involve the following areas/processes:

### 1.1 Supplies—in Charge of:

Controlling the inventory of Agreement Kits (agreement forms, envelopes and boxes) for retail operations;

Making the purchase of Agreements;

Preparing and sending (Logistics) the Agreement Kits to units.

Costs involved in this process:

Administrative costs;

Posting costs.

### 1.2 Operational Units—in Charge of:

Recording retail operations in specific forms;

Sending forms of approved operations to the custodian company.

Costs involved in this process:

Administrative costs;

Posting costs.

### 1.3 It Area—in Charge of:

Providing information on the agreements approved in retail operations, through its legacy application;

Providing information on the credits granted to clients, through a legacy application;

Costs involved in this process:

Administrative costs, once the processes/information are not available for enquiries, in a unique database.

### 1.4 Agreement Formalization Area—in Charge of:

Controlling pending documents for the deduction of commission;

Formalizing processes without using Digital Certificate.

Costs involved in this process:

Administrative costs involving the management of physical documents.

### 1.5 Document Custodian Company:

Receiving and verifying the documentation received;

Digitalizing physical documents;

Safeguarding agreements (custody);

Attach physical agreements, when required;

Costs involved in this process;

Receipt;

Digitalization;

Custody; and

Attachment.

### 1.6 Audit/Ombudsman—in Charge of

Lawsuits (Consumer Lawsuit (Procon/Decon/Procon/Small-Claims Court/Attorney's Fees) filed by clients against the Financial Institution as a result of the failure to locate the agreement entered into by the parties);

Costs involved in this process;

Administrative costs;

Consumer lawsuit costs.

Patent document PI0804993-9 filed on Nov. 07, 2008, entitled “control system for goods marketed at a point of sale” sets forth a system through which it will be possible to obtain an accurate indication of market behavior, not only with respect to items marketed through a network in which this system is embodied, but also in relation to items that, although they are available at the point of sale, are not marketed through the network. The system is based on the operations of a database that records all items marketed at the point of sale, whether these items are made available or not by the network, and allows, from the interpretation of representative data about items marketed, to assess the market behavior with respect, for instance, to a certain item marketed, the location of a certain point of sale and the space-time of operation of a certain point of sale, thus defining criteria that can be used in the strategy to establish a certain item, in the strategy to market the launch of new items, the strategy to allocate a certain item to a sector, among others.

Patent document PI0312774-5 filed on Jul. 17, 2003, entitled “methods to provide a certificate state service, to retrieve the status of an authentication certificate issued by a certifying authority and to perform an operation between one party and the other party so as to transfer the control of an information object authenticated, as well as a certificate status services to provide accurate and convenient status indications of authentication certificates issued by certifying authorities” sets forth a configurable Certificate Status, which is directed and capable of retrieving the status of any Certifying Authority (“CA”) disclosed. The CSS can be used by a Public Service and a Reliable Custody Service (TCU) and compatible systems or applications the roles of which are to validate an individual's right to perform an action required, the authenticity of electronic information objects submitted and the status of authentication certificates used in verifying the digital signature and user authentication processes. The verification of validity in authentication certificates is made by enquiring an Issuing CA. Traditionally, in order to build a Public Key Infrastructure (PKI) required to validate certificates, complex relations are formed by crossed certification between CAs, or by the use of PKI bridges. The interoperation involving the PKI and CA is treated based on a different standpoint, focused on establishing a reliable environment suitable for the creation, execution, maintenance, transfer, retrieval and destruction of original electronic information objects that can also be transferrable records (the ownership may change obligations). A TCU is only related to a set known as “Approved CAs”, although they can support several business environments, and, within this set of CAs, only with those certificates that are associated with TCUU user accounts. The building of PKI and CA reliable relations is not necessary, once the CSS obtains a reliable environment through the investigation of only CAs approved and the maintenance of state caches of valid certificates.

Patent document PI0903508-7 filed on Jul. 21, 2009, entitled “delivery management process” sets forth an innovative logistic process used in managing deliveries, eliminating the use of paper through the use of digital signature operations and results focused on efficiency, security, total control and low cost of installation and maintenance. This invention is a process basically consisting of seven steps, that is, preparation for delivery; shift to the client; verification of goods by the client; confirmation of delivery; shift of return, verification of delivery by the management company and actions in the event of return. In sum, the process operates as follows: Firstly, the person in charge of verification generates the digital certification through the system of the company. Secondly, the driver leaves the place of origin to perform the delivery. When arriving in the place of destination, the goods are verified by the client. In this moment, the driver swipes the badge and types the password for identification, and the clients swipes the card, typing the password so as to digitally sign the receipt of the delivery, when, via radiofrequency, the delivery is confirmed and the data are stored online through the share of information between the server of the company and the server of the delivery card management company. Lastly, the driver hands in the printed receipt to the client and returns to the company, so that the person in charge of verification can extract the exit−return=delivery report and verify whether everything occurred properly.

By analyzing the documents referred to above from a state-of-the-art standpoint, as it may be observed, none fully states the constructive characteristics of the legally valid electronic operation process subject to this patent.

Therefore, studies aiming to eliminate these problems had been conducted over time, and, as a result, this legally valid electronic operation process has been developed, which then resulted in an integrated system.

### SUMMARY

The purposes of this patent are to provide a legally valid electronic operation process based on a new work methodology applied to retail products and processes, substitute paper-based operations for legally valid electronic operations, assure the legal validity in electronic operations by implementing signature software through handwriting biometrics, under the legislation in force, reduce by 70% the costs directly and indirectly involved in paper-based processes, optimize spaces of companies so as to increment other areas, eliminating the storage of paper and enabling to promptly and easily location information, once the information will be made available to all online network and to benefit from individual abilities, reallocating professionals to manage processes, without needing to hire workforce.

As a result, the process subject to this patent assures the system total integrity, authenticity, no repudiation and non-retroactivity.

It also brings Institutional Image benefits such as prompt compliance with consumer demands (Procon/Ombudsman) and/or Central Bank, including the financial institution in the social and environmental responsibility project presented by Bacen at Rio+20 (Notice 041/2012)—process for financial institutions; as well as Business Companies, mitigate the distress with clients and suppliers caused by a pending physical agreement.

This new Work Methodology can be applied to all retail products, such as:

Payroll deductible loan;

Vehicle financing;

Real estate financing;

Consortia;

Insurance;

Credit card;

Consumer's direct credit; etc.

### BRIEF DESCRIPTION OF DRAWINGS

To supplement this description, in order to obtain better understanding of the characteristics of this patent, also in practical terms, the description is accompanied by a set of drawings, which is exemplified as follows:

FIG. 1 represents the flowchart of the current process that is not integrated;

FIG. 2 represents the flowchart of the legally valid electronic operation process subject to this patent;

FIG. 3 represents the comparative flowchart of the processes, that is, the current process and the process subject to this patent.

FIG. 4 represents the flowchart of the legally valid electronic operation process subject to this patent.

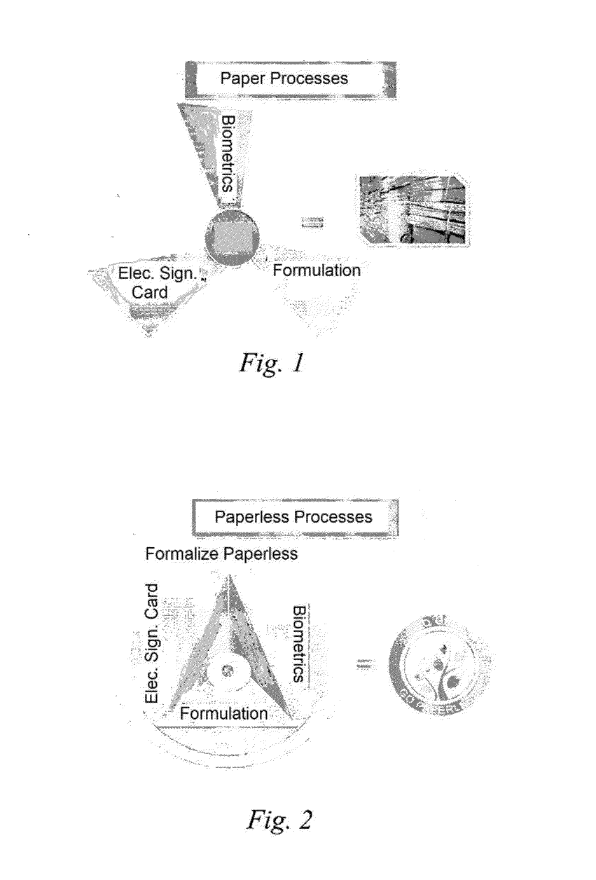

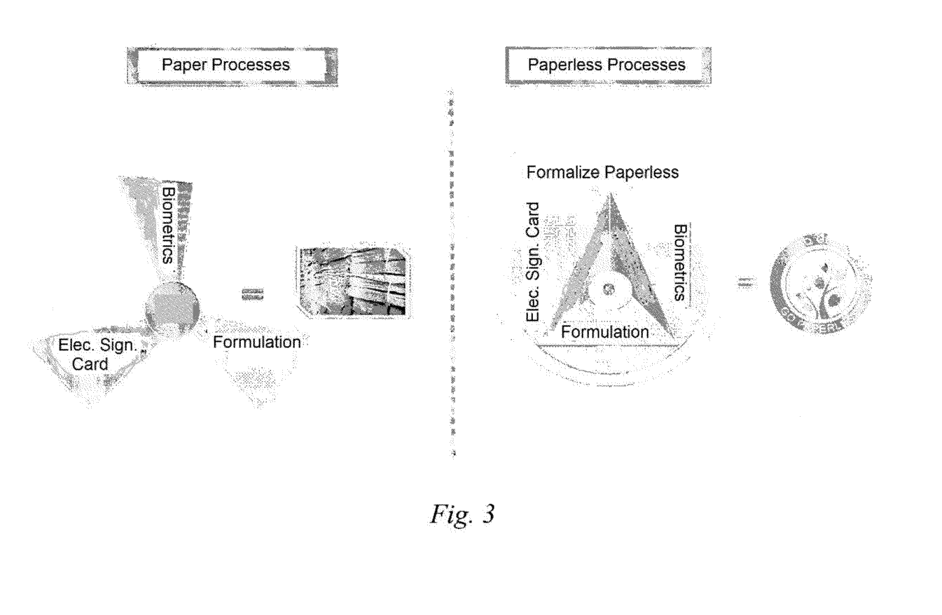

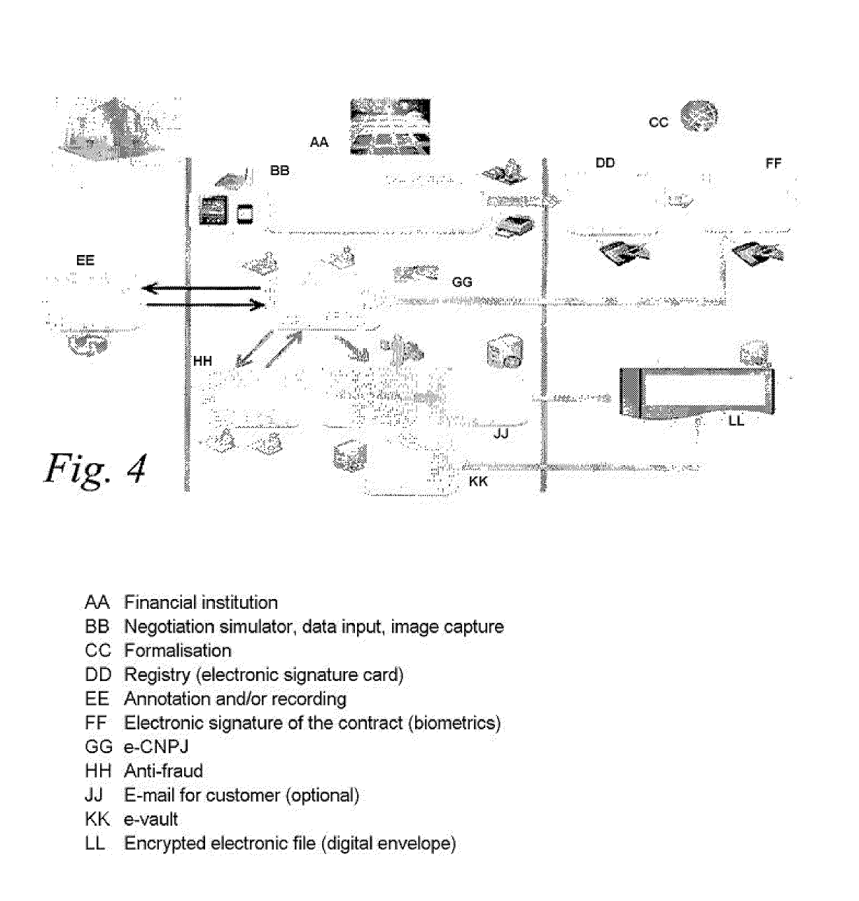

### DETAILED DESCRIPTION OF THE PREFERRED EMBODIMENT

In accordance with the figures above and their details, the legally valid electronic operation process consists of a negotiation simulator, data entry and capture of image that transmits the record (electronic signature card) for an electronic signature on the agreement (biometrics), through e-CNPJ and back-office (formalization), sending and receiving data for entry and recording, so as to verify the existence of frauds, and, if the process is in compliance, the record is send to the Treasury, and an email is sent to the client via encrypted electronic file (digital envelope) and forwarded right after to e-vault.

There is no knowledge of a legally valid electronic operation process that gathers all building and operational characteristics referred to above and that directly or indirectly is or was as effective as the operational process subject to this patent.

Upon being described and illustrated, this invention may undergo several changes and variations in its method of operation, provided that such changes and variations do not distance it from the spirit and scope of the invention, as defined in the scope of claims.

What is claimed is:

1. A PAPERLESS PROCESS APPLIED TO LEGALLY VALID ELECTRONIC OPERATIONS CARRIED OUT THROUGH HANDWRITING BIOMETRICS REFERRED TO AS PAPERLESS SOLUTION, comprising; a negotiation simulator, data entry and capture of image that transmits the record (electronic signature card) for an electronic signature on the agreement (biometrics), through e-CNPJ and back-office (formalization), sending and receiving data for entry and recording, so as to verify the existence of frauds, and, if the process is in compliance, the record is send to the Treasury, and an email is sent to the client via encrypted electronic file (digital envelope) and forwarded right after to e-vault.
